(19) United States
(12) Patent Application Publication
(10) Pub. No.: US 2017/0122752 A1
(43) Pub. Date: May 4, 2017

(54) METHOD OF COMPUTING ROUTES FOR MULTIPLE-USER'S COMMUTES AND APPARATUS THEREOF

(71) Applicant: LEAUTO INTELLIGENT TECHNOLOGY (BEIJING) CO. LTD, Chaoyang District Beijing (CN)

(72) Inventors: Binglin FENG, Chaoyang District Beijing (CN); Yi CHEN, Chaoyang District Beijing (CN)

(21) Appl. No.: 14/978,847

(22) Filed: Dec. 22, 2015

(30) Foreign Application Priority Data
Nov. 2, 2015 (CN) 2015107317074

(51) Int. Cl. G01C 21/34

(52) U.S. Cl. CPC G01C 21/34

(57) ABSTRACT

The present disclosure provides a method of computing routes for multiple-user's commutes and apparatus thereof. Wherein, the method includes: locating each of the multiple users to obtain a location coordinate of each of the multiple users; computing the central point or central zone according to the location coordinates of the multiple users, wherein the central point or central zone is a visual center or central zone; recommending a route to said multiple users based on said central point or said central zone, respectively, the present disclosure makes sure that each user takes about the same time to arrive at the meeting location, thus avoiding time being wasted in waiting one or another user.

### CROSS-REFERENCE TO RELATED APPLICATIONS

This application is based upon and claims priority to Chinese Patent Application 201510731707.4, titled “method of computing routes for multiple-user's commutes and apparatus thereof”, filed 2 Nov. 2015, the entire contents of which are incorporated herein by reference.

### FIELD OF TECHNOLOGY

The present disclosure generally relates to a technical field of navigation, and more particularly to a method of computing routes for multiple-user's commutes and apparatus thereof.

### BACKGROUND

Map and navigation software is used more and more frequently and becomes more and more convenient with the fast development of the Internet map application. However, current map and navigation software only supports the route computation and navigation involving a single starting point, that is, route inquiry and real-time navigation can only function when a starting point and a destination are determined.

Existent map and navigation software provides an “in field-of-view” search function, whereby the user may search among the points of interest within the displayed interface range to determine a point and when multiple users start from different locations, the user needs firstly to determine an intended destination, but the location determined using existent map and navigation software does not give balanced consideration to the location of multiple users making some of them be nearer from the selected location and have to wait those of them who are farther and naturally spend more time on the road and also being unable to ensure the users arrive at the meeting point at about the same time.

### SUMMARY

Given the above-related problem, the present disclosure is proposed with the objective of providing a method of computing routes for multiple user's commutes and a corresponding apparatus of computing routes for multiple user's commutes that are capable of solving, or at least partially solving, the above-related problem.

According to one aspect of the present disclosure, there is provided a method of computing routes for multiple user's commutes, which includes:

locating each of the multiple users to obtain a location coordinate of each user;

computing a central point or central zone according to the location coordinates of the multiple users, wherein the central point or central zone is a visual center or central zone; and

recommending a route to the multiple users on the basis of the central point or central zone, respectively.

According to another aspect of the present disclosure, there is provided an apparatus of computing routes for multiple user's commutes, including:

one or more processors; and

a memory; and

one or more programs, wherein one or more programs are stored in the memory, and when executed by the one or more processors, the one or more programs cause the one or more processors to perform:

locating each of the multiple users to obtain a location coordinate of each user;

computing a central point or central zone according to the location coordinates of said multiple users, wherein said central point or central zone is a visual center or central zone;

recommending a route to said multiple users based on said central point or said central zone, respectively.

According to the proposal of the present disclosure, each of the multiple users is located and the location coordinate of each of the multiple users are found, the central point or central zone is computed according to the location coordinates of the multiple users, and from this central point or central zone a route is proposed to each of the multiple users so that each user takes about the same time to arrive at the meeting location, thus avoiding time being wasted in waiting one another of the users.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a flow chart showing a method of computing routes for multiple user's commutes according to an embodiment of the present disclosure;

FIG. 2 is a flow chart showing a method of computing routes for multiple user's commutes according to another embodiment of the present disclosure;

FIG. 3 is a schematic diagram of a convex hull zone according to the present disclosure;

FIG. 4 is a schematic diagram of a central point or central zone according to the present disclosure;

FIG. 5 is a structural block diagram showing an apparatus of computing routes for multiple user's commutes according to an embodiment of the present disclosure;

FIG. 6 is a structural block diagram showing an apparatus of computing routes for multiple user's commutes according to another embodiment of the present disclosure;

FIG. 7 is a structural block diagram showing an apparatus of computing routes for multiple user's commutes according to another embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

In the present disclosure, the multiple users may form a user group for their departing and access this group using a same authentication code and, using the navigation software in their terminal device, enter into the route navigation interface, the means by which they access the user group being not limited by using a same authentication code and other authentication means being also possible, for example using user ID, which are not to be qualified here.

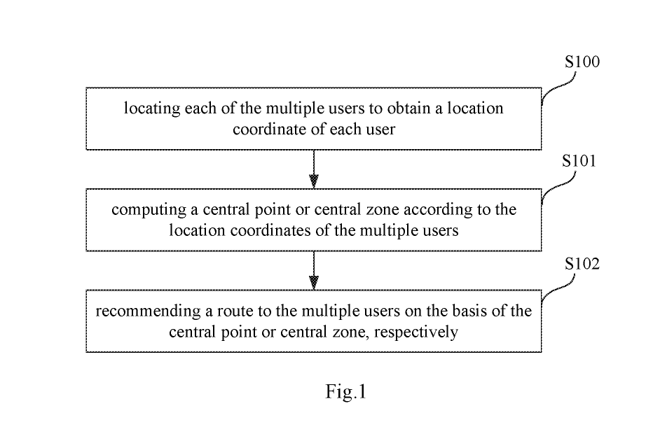

FIG. 1 is a flow chart showing a method of computing routes for multiple user's commutes according to an embodiment of the present disclosure. As shown in FIG. 1, the method includes the following steps:

Step S100: locating each of the multiple users to obtain a location coordinate of each user.

In particular, each user of the multiple users is located using the locating function of the GPS available in the terminal device and the obtained location coordinate of each user are used as the starting point of each user.

Step S101: computing a central point or central zone according to the location coordinates of the multiple users.

Wherein, the central point or central zone is a visual center or central zone, referring to the user's field of view being at the central point or central zone on the navigation page.

Step S102: recommending a route to the multiple users on the basis of the central point or central zone, respectively.

In this embodiment, the user may select the central point or a point near the central point or select a point in the central zone or a point near the central zone and, with the chosen point as the destination, a route is recommended respectively to the multiple users.

According to the method provided for in the above embodiment of the present disclosure, each of the multiple users is located and the location coordinate of each of the multiple users are found, the central point or central zone is computed according to the location coordinates of the multiple users, and from this central point or central zone a route is proposed to each of the multiple users so that each user takes about the same time to arrive at the meeting location, thus avoiding time being wasted in waiting one another of the users.

The technical proposal of the present disclosure is described in more detail below with an example consisting of three or more users.

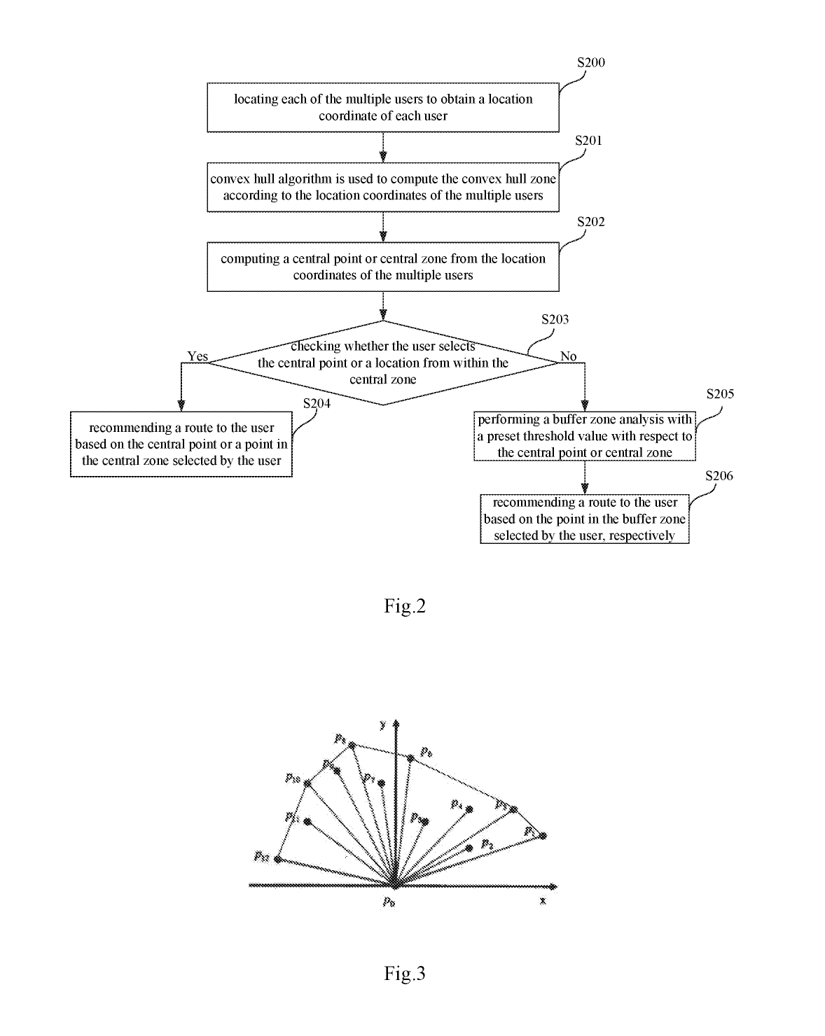

FIG. 2 is a flow chart showing a method of computing routes for multiple user's commutes according to another embodiment of the present disclosure. As shown in FIG. 2, this method includes the following steps:

Step S200: locating each of the multiple users to obtain a location coordinate of each user.

In particular, each user of the multiple users is located using the locating function of the GPS available in the terminal device and the obtained location coordinate of each user are used as the starting point of each user.

Step S201: convex hull algorithm is used to compute the convex hull zone according to the location coordinates of the multiple users.

Wherein, the convex hull zone is a polygon region that contains the location coordinates of the multiple users.

When three or more users are involved, an algorithm is available for computing the convex hull. Wherein, the convex hull can be viewed as a zone formed by the boundary of a planar point set and, in the present disclosure, the convex hull is computed with the location coordinates of all the users constituting the planar point set and the set point of all the users not to exceed the hull boundary. The computation of a convex hull zone is described in ampler detail using FIG. 3 as an example: assuming 13 users, donated by P0-P12, after determining the location coordinates of each user as described in Step S200, select one of the coordinate points as the origin, say point P0, construct a connection line from P0 to each of the rest points, find the longest line segment, say P0P8, and the next longest line segment, say P0P1, and draw a line connecting P8 and P1. A triangle P0P1P8 is constructed in which P1P8 intersects P0P6 and P0P3, the longest of which is selected, say P0P3. Draw a line connecting P8 and P3, draw a line connecting P1 and P3, and two triangles P0P3P8 and P0P1P3 are constructed, in which P0P6 intersects P3P8. Then draw a line connecting P8 to P6, P6 to P3, and P3 to P1 respectively. Repeat in a similar way until no connection edge intersects any other line segments, and a convex hull zone is thus generated, hence minimizing the choice range for the meeting point.

Step S202: computing a central point or central zone according to the location coordinates of the multiple users.

Wherein, the central point or central zone is a visual center or central zone.

The convex hull zone computed in Step 201 is too large in zone and the location points available for choosing are too many. To further narrow down the selection range of location points and to ensure each user arrives at about the same time, this exemplary embodiment computes further the central point or central zone, which is located within the computed convex hull zone.

A convex hull zone was computed in Step 201, which hull zone is a polygon region, and now the computation method for finding the central point or central zone is described in more details with this particular polygon region as an example:

If the convex hull zone is a triangle region, the central point may be computed out in this way: a gravity center of the triangle region is computed out and used as the central point; in other words, when the convex hull zone computed out according to the location coordinates of the multiple users is a triangle, the central point coincides with the gravity center of the triangle (the intersection of the medians).

If the convex hull zone is a quadrilateral region, the central point may be computed in this way: find out a middle point of the longer diagonal line of this quadrilateral region and use this middle point as the central point; in particular, connect all the apexes of the quadrilateral to get the two diagonal lines, and take the middle point of the longer diagonal line as the central point of this quadrilateral region.

If the convex hull zone is a pentagon region or polygon region with more than five sides, the central point may be computed in this way: draw a line to join the two immediate neighboring apexes of each apex of this polygon, the intersecting area enclosed by these lines is the desired central zone. The method is illustrated in more details using a pentagon region as an example, the central zone being computed in a similar fashion when the convex hull is a polygon region with more than five sides: the two immediate neighboring apexes of each apex of the pentagon are joined using a line, and the intersecting area enclosed by these connection lines is the central zone, as shown in FIG. 4. FIG. 4 also shows the schematic diagram of the central zone of a hexagonal convex hull zone but does not show for convex hulls in a shape of polygon with more than 6 sides.

The central zone computed in Step 202 may contain many locations of various types, for instance shop, cinema, and bus station. Each type may offer a plurality of locations for the selection by the user. For convenience of use and to satisfy the user's requirements, the method in this embodiment includes the following step as well: recommending a location of appropriate type within this central zone to the user of the multiple users according to this user's choice of the type of location within the central zone.

Step S203: checking whether the user selects the central point or a location from within the central zone; if yes, proceed to Step 204; otherwise, proceed to Step 205.

The central point or central zone is computed in Step S202, nevertheless this central point or central zone might not be easily accessible or might not satisfy the purpose of the users, say shopping or movie watching, in other words, the users, not satisfied with the said central point or the locations within the said central zone, might not chose the central point nor select from the central zone as their meeting point; in this case, it becomes necessary to judge whether the user has chosen the central point or a point in the central zone so as to determine whether to recommend a route with the central point or a point in the central zone as the destination.

Step S204: recommending a route to the user based on the central point or a point in the central zone selected by the user.

Where it is judged that the user has chosen the central point or a point in the central zone, a route is recommended to each user with the central point or the point in the central zone as the destination and with due consideration given to the traffic condition.

Step S205: performing a buffer zone analysis with a preset threshold value with respect to the central point or central zone.

If it is judged that the user does not select the central point or a point in the central zone, it means the central point or central zone does not afford a satisfactory meeting point to the user. This step, based on the central point or central zone, the user's outing purpose, and the traffic and road condition, etc., performs buffer zone analysis with a preset threshold with respect to the central point or central zone. For instance, a buffer zone of 0.5 km or lkm or 2 km radius with the central point or central zone as the circle center may be created, which buffer zone shall not extend out of the convex hull.

Step S206: recommending a route to the user based on the point in the buffer zone selected by the user, respectively.

The user may select a point from the buffer zone created in Step S205 and use this point as the meeting point, or the destination, and a route is recommended to each user with this point as the destination.

The above embodiment describes an outing scenario involving three or more users. There may be an outing scenario where only two users are involved and, in this case, there exists no such a thing as convex hull but the central point can be computed directly and, in particular, in this way: find out the middle point on the line segment joining the location points of the two users and use this middle point as the central point, as shown in FIG. 4.

If it is judged that the user does not select the above central point, this means the user is not satisfied with selecting the central point as the meeting point and, in this case, buffer zone analysis with a preset threshold may be performed with respect to the central point having regard to the central point condition, the outing purpose, the traffic and road condition. For instance, a circle buffer zone of 0.5 km or lkm or 2 km radius with the central point as the circle center may be created.

According to the methods provided by the above embodiments of the present disclosure, each of the multiple users is located and their location coordinates found and, using the convex hull algorithm and based on the location coordinates of the multiple users, the convex hull zone is computed, which narrows down the selection range of the meeting point, and the central point or central zone computed according to the location coordinates of the multiple users further narrows down the selection range, and a route is recommended to the user based on the central point or a point in the central zone selected by the user, or alternatively, when the user is not satisfied with the central point or central zone, buffer zone analysis with a preset threshold value is performed with respect to the central point or central zone and a route is recommended to the user based on the point in the buffer zone selected by the user so that each user takes about the same time to arrive at the meeting point thus avoiding time being wasted in waiting one another of the users, and it will be more convenient if the meeting point is determined with consideration given to the purpose of the user's outing.

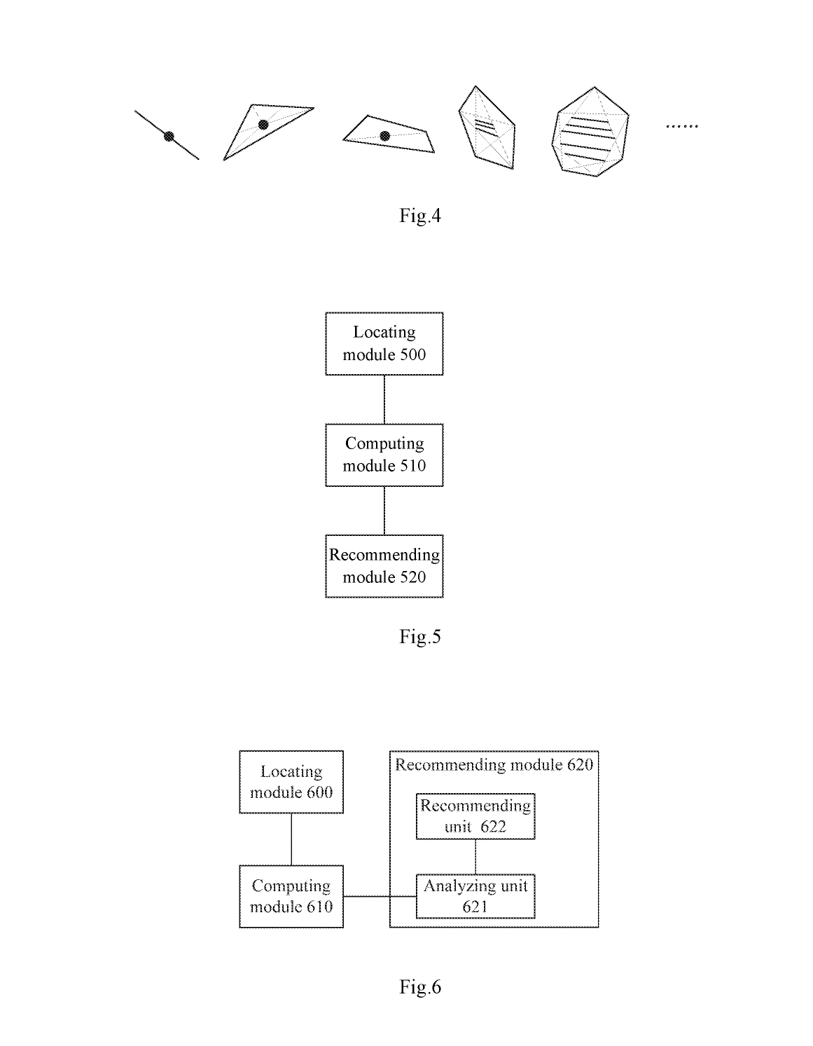

FIG. 5 is a structural block diagram showing an apparatus of computing routes for multiple user's commutes according to an embodiment of the present disclosure. As shown in FIG. 5, this apparatus includes: a locating module 500, a computing module 510, and a recommending module 520.

Locating module 500, configured to locate each of the multiple users to obtain a location coordinate of each user.

In particular, each user of the multiple users is located using the locating function of the GPS available in the terminal device and the obtained coordinates of each user are used as the starting point of each user.

Computing module 510, configured to compute the central point or central zone from the coordinates of each of the multiple users, wherein the central point or central zone is a visual center or central zone.

Wherein, the central point or central zone is the visual center or central zone, referring to the user's field of view being at the central point or central zone on the navigation page.

Recommending module 520, configured to recommend a route to the multiple users based on the central point or central zone, respectively.

In this embodiment, the user may select the central point or a point near the central point or select a point in the central zone or a point near the central zone and, with the chosen point as the destination, a route is recommended respectively to the multiple users.

According to the apparatus provided for by the above embodiment of the present disclosure, each of the multiple users is located and the coordinates of each of the multiple users are found; the central point or central zone is computed according to the location coordinates of the multiple users; from this central point or central zone a route is recommended to each of the multiple users so that each user takes about the same time to arrive at the meeting location, thus avoiding time being wasted in waiting one another of the users.

FIG. 6 is a structural block diagram showing an apparatus of computing routes for multiple user's commutes according to another embodiment of the present disclosure. Multiple users constitute a user group and they access the group using a same authentication code. As shown in FIG. 6, this apparatus includes: a locating module 600, a computing module 610, and a recommending module 620.

Locating module 600, configured to locate each of the multiple users to obtain a location coordinate of each user;

Computing module 610, configured to compute a central point or central zone from the coordinates of the multiple users, the central point or central zone is a visual center or central zone.

In the case of three of more users, the computing module 610 is further configured to: compute a convex hull zone according to the location coordinates of the multiple users using the convex hull algorithm, wherein the convex hull zone is a polygon region that contains the location coordinates of the multiple users.

When three or more users are involved, an algorithm is available for computing the convex hull. Wherein, the convex hull can be viewed as a zone formed by the boundary of a planar point set and, in the present disclosure, the convex hull is computed with the location coordinates of all the users constituting the planar point set and the set point of all the users not to exceed the hull boundary, therefore narrowing down the selection range of the meeting point.

The computed convex hull zone is too large in area and the location points available for choosing are too many, so to further narrow down the selection range of location points and to ensure each user arrives at about the same time, this embodiment computes further the central point or central zone, which is located within the above convex hull zone. The computation method for the central point or central zone differs with the convex hull type:

If the convex hull zone is a triangle region, the computing module 610 is further configured to: compute a gravity center of the triangle region, the gravity center being taken as the central point.

If the convex hull zone is a quadrilateral region, the computing module 610 is further configured to: compute a middle point of the longer diagonal line of the quadrilateral region, the middle point being taken as the central point.

If the convex hull zone is a pentagon region or a polygon region with more than five sides, the computing model 610 is further configured to: compute an intersecting area enclosed by the lines, each of which joins the two immediate neighboring apexes of each apex of the convex hull, the enclosed intersecting area being taken as the central point.

Recommending module 620, configured to recommend a route to the multiple users based on the central point or central zone, respectively.

Optionally, recommending model 620 is also configured to: recommend an appropriate type location within this central zone to one of the multiple users according to the user's selection of the type of location within the central zone.

Optionally, when the multiple users consist of two users, computing module 610 is further configured to: compute a middle point on a line segment joining the location points of the two users, the middle point being taken as the central point.

Optionally, if the user selects the central point or a point in the central zone, recommending module 620 is further configured to: recommend a route to the user based on the central point or the point in the central zone selected by this user.

The central point or central zone is computed by computation, nevertheless this central point or central zone might not be easily accessible or might not satisfy the purpose of the users, say shopping or movie watching, in other words, the users, not satisfied with the said central point or the locations within the said central zone, might not chose the central point nor select from the central zone as their meeting point; in this case, it becomes necessary to recommend another point to the user, and, if this point is chosen by the user, recommend a route to the user. The particular mode of implementation is as below:

In case the user among the multiple users does not select the central point or a point in the central zone, the recommending module 620 further includes: an analyzing unit 621 and a recommending unit 622.

Analyzing unit 621, configured to perform a buffer zone analysis with a preset threshold value with respect to the central point or central zone.

For example, computing a buffer zone of 0.5 km or lkm or 2 km radius with the central point or central zone as the circle center, which buffer zone shall not extend out of the convex hull.

Recommending unit 622, configured to recommend a route to the user based on the point in the buffer zone selected by the user.

According to the apparatus provided by the above embodiment of the present disclosure, each of the multiple users is located and their location coordinates found and, using the convex hull algorithm and based on the location coordinates of the multiple users, the convex hull zone is computed, which narrows down the selection range of the meeting point, and the central point or central zone computed according to the location coordinates of the multiple users further narrows down the selection range, and a route is recommended to the user based on the central point or a point in the central zone selected by the user, or alternatively, when the user is not satisfied with the central point or central zone, buffer zone analysis with a preset threshold value is performed with respect to the central point or central zone and a route is recommended to the user based on the point in the buffer zone selected by the user so that each user takes about the same time to arrive at the meeting point thus avoiding time being wasted in waiting one another of the users, and it will be more convenient if the meeting point is determined with consideration given to the purpose of the user's outing.

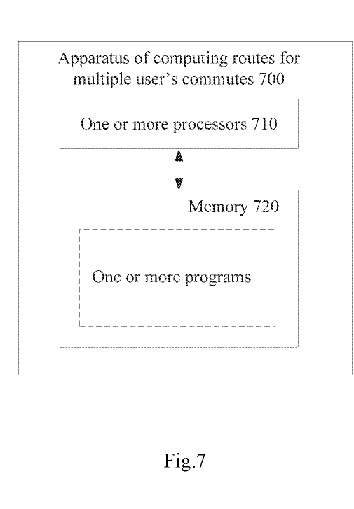

FIG. 7 is a structural block diagram showing an apparatus of computing routes for multiple user's commutes according to another embodiment of the present disclosure. The apparatus 700 includes: one or more processors 710; and a memory 720; one or more programs, wherein one or more programs are stored in the memory, and when executed by the one or more processors, the one or more programs cause the one or more processors to perform the method provided in the present disclosure.

The above description has presented and illustrated many exemplary embodiments of the present disclosure, and however, as stated above, it shall be appreciated that the present disclosure is not limited to the implementations disclosed herein, providing these exemplary embodiments shall not be deemed as excluding other embodiments. Instead, the technical solutions in the present disclosure may be applied in any other combinations, variations and environments, and may be modified based on the above teaching or technologies or knowledge in related fields within the conceiving scope of the present disclosure. Any modifications or changes performed by one of ordinary skill in this art without departing from the spirit and scope of the present disclosure shall fall within the protection scope as defined by appended claims.

1. A method of computing routes for multiple user's commutes, comprising:
locating each of the multiple users to obtain a location coordinate of each user;
computing a central point or central zone according to the location coordinates of said multiple users, wherein said central point or central zone is a visual center or central zone; and
recommending a route to said multiple users based on said central point or said central zone, respectively.

2. The method according to claim 1, wherein, when said multiple users comprise three or more users, before computing a central point or central zone according to location coordinates of said multiple users, said method further comprises:
computing a convex hull zone according to the location coordinates of said multiple users using the convex hull algorithm, wherein said convex hull zone is a polygon region that contains the location coordinates of said multiple users.

3. The method according to claim 2, wherein, when said convex hull zone is a triangle region, the computing a central point or central zone according to location coordinates of multiple users further comprises:
computing a gravity center of said triangle region and taking said gravity center as the central point.

4. The method according to claim 2, wherein, when said convex hull zone is a quadrilateral region, the computing a central point or central zone according to location coordinates of the multiple users further comprises:
computing a middle point of a longer diagonal line of said quadrilateral region and using said middle point as the central point.

5. The method according to claim 2, wherein, when said convex hull zone is a pentagon region or a polygon region with more than five sides, the computing a central point or central zone according to location coordinates of the multiple users further comprises:
computing an intersecting area enclosed by lines, each of which joins the two immediate neighboring apexes of each apex of the convex hull, said enclosed intersecting area being taken as the central zone.

6. The method according to claim 5, wherein, said method further comprises:
recommending an appropriate type of location within said central zone to one of said multiple users according to the user's selection of the type of location within said central zone.

7. The method according to claim 1, wherein, when said multiple users are two users, the computing a central point or central zone according to location coordinates of multiple users further comprises:
computing a middle point on a line segment joining location points of said two users and taking said middle point as the central point.

8. The method according to claim 1, wherein, if a user of said multiple users selects said central point or a point in said central zone, the recommending a route to said multiple users based on said central point or said central zone further comprises:
recommending a route to said user based on said central point or the point in said central zone selected by the user;
if said user does not select said central point or a point in said central zone, the recommending a route to said multiple users based on said central point or said central zone further comprises:
performing a buffer zone analysis with a preset threshold value with respect to said central point or said central zone; and
recommending a route to said user based on the point in the buffer zone selected by said user, respectively.

9. The method according to claim 1, wherein, said method further comprises:
constituting a user group, wherein said multiple users use a same authentication code to access the user group.

10. An apparatus of computing routes for multiple user's commutes, comprising:
one or more processors; and
a memory; and
one or more programs, wherein one or more programs are stored in the memory, and when executed by the one or more processors, the one or more programs cause the one or more processors to perform:
locating each of the multiple users and getting location coordinates of each user;
computing a central point or central zone according to the location coordinates of said multiple users, wherein said central point or central zone is a visual center or central zone;
recommending a route to said multiple users based on said central point or said central zone, respectively.

11. The apparatus according to claim 10, wherein the one or more processors are further configured to perform:
when said multiple users comprise three or more users, performing a computation using the convex hull algorithm according to the location coordinates of said multiple users to obtain a convex hull zone, wherein said convex hull zone is a polygon region that contains the location coordinates of said multiple users.

12. The apparatus according to claim 11, wherein the one or more processors are further configured to perform:
when said convex hull zone is a triangle region, computing a gravity center of said triangle region and taking said gravity center as the central point.

13. The apparatus according to claim 11, wherein the one or more processors are further configured to perform:
when said convex hull zone is a quadrilateral region, computing a middle point of a longer diagonal line of said quadrilateral region and using said middle point as the central point.

14. The apparatus according to claim 11, wherein the one or more processors are further configured to perform:
when said convex hull zone is a pentagon region or a polygon region with more than five sides, computing a intersecting area enclosed by lines each of which joins the two immediate neighboring apexes of each apex of the polygon, said enclosed intersecting area being taken as the central zone.

15. The apparatus according to claim 14, wherein the one or more processors are further configured to perform:
recommending an appropriate type location within said central zone to one of said multiple users according to the user's selection of the type of location within said central zone.

16. The apparatus according to claim 10, wherein the one or more processors are further configured to perform:
when said multiple users are two users, computing a middle point on a line segment joining location points of said two users and taking said middle point as the central point.

17. The apparatus according to claim 10, wherein the one or more processors are further configured to perform:
if a user of said multiple users selects said central point or a point in said central zone, recommending a route to said user based on said central point or the point in said central zone selected by the user;
wherein the one or more processors are further configured to perform: if said user does not select said central point or a point in said central zone, performing a buffer zone analysis with a preset threshold value with respect to said central point or said central zone;
wherein the one or more processors are further configured to perform: recommending a route to said user based on the point in the buffer zone selected by said user, respectively.

18. The apparatus according to claim 10, wherein the one or more processors are further configured to perform: constituting a user group, wherein said multiple users use a same authentication code to access the user group.
